(19) United States
(12) Patent Application Publication
(10) Pub. No.: US 2019/0171714 A1
(43) Pub. Date: Jun. 6, 2019

(54) Artificial Intelligence Quality Measures Data Extractor

(71) Applicant: Safermed, LLC d/b/a SaferMD, LLC, New York, NY (US)

(72) Inventors: Brian Gale, Bronx, NY (US); Ted Sabety, Pleasantville, NY (US)

(73) Assignee: Safermed, LLC d/b/a SaferMD, LLC, New York, NY (US)

(21) Appl. No.: 16/220,072

(22) Filed: Dec. 14, 2018

Related U.S. Application Data
(63) Continuation-in-part of application No. 12/905,980, filed on Oct. 15, 2010.
Application No. 12/905,980 is a continuation-in-part of application No. 12/408,686, filed on Mar. 21, 2009.
Application No. 12/408,686 is a continuation-in-part of application No. 12/361,081, filed on Jan. 28, 2009, now abandoned.
(60) Provisional application No. 62/612,824, filed on Jan. 2, 2018.
(60) Provisional application No. 61/299,268, filed on Jan. 28, 2010.
(60) Provisional application No. 61/297,773, filed on Jan. 24, 2010.
(60) Provisional application No. 61/262,431, filed on Nov. 18, 2009.
(60) Provisional application No. 61/255,773, filed on Oct. 28, 2009.
(60) Provisional application No. 61/252,097, filed on Oct. 15, 2009.
(60) Provisional application No. 61/252,100, filed on Oct. 15, 2009.
(60) Provisional application No. 61/038,729, filed on Mar. 21, 2008.

(51) Int. Cl. G06F 17/27; G06F 16/33; G06F 16/335; G06N 3/08

(52) U.S. Cl. CPC G06F 17/2795; G06N 3/082; G06F 16/335; G06F 16/3344

(57) ABSTRACT

The claimed invention uses a combination of Natural Language Processing and Machine Learning as an automated data extractor to automatically extract features from unstructured medical reports in order to ensure compliance with QPP measures by using the extracted features to calculate service quality levels.

### PRIORITY CLAIM

This is a utility patent application. It claims priority is a non-provisional continuation of U.S. patent application No. filed on Jan. 2, 2018, which is hereby incorporated by reference in its entirety for all that it teaches.

This application is a continuation-in-part of U.S. patent application Ser. No. 12/905,980 filed on Oct. 15, 2010, which claims priority to U.S. Provisional Patent Application No. 61/299,268 filed on Jan. 28, 2010; U.S. Provisional Patent Application No. 61/297,773 filed on Jan. 24, 2010; U.S. Provisional Patent Application No. 61/262,431 filed on Nov. 18, 2009; U.S. Provisional Patent Application No. 61/255,773 filed on Oct. 28, 2009; U.S. Provisional Patent Application No. 61/252,097 filed on Oct. 15, 2009; U.S. Provisional Patent Application No. 61/252,100 filed on Oct. 15, 2009 and is a Continuation in Part to U.S. patent application Ser. No. 12/408,686, filed on Mar. 21, 2009 is a continuation-in-part of U.S. patent application Ser. No. 12/361,081 filed on Jan. 28, 2009 and which further claims priority to provisional application 61/038,729, filed on Mar. 21, 2008, all of which are hereby incorporated by reference in their entireties for all that they teach.

### FIELD OF INVENTION

CMS's Quality Payment Programs (QPP) adjusts Medicare payments to reward healthcare providers who comply with best practices. QPP has the potential to motivate providers and practices to significantly improve clinical practice quality and safety. However, healthcare providers must overcome considerable challenges to participate in the program. The claimed invention seeks to overcome the biggest hurdle. The biggest challenge to participation in QPP is to evaluate unstructured data sources to determine the compliance rates required for measures data.

### BACKGROUND

Although electronic health records (EHR) contain structured data fields, much medical documentation exists in unstructured text reports. For example, one measure requires documentation of whether and when a diagnostic radiologist notified the referring clinician of an actionable finding. That documentation may exist only in the radiologist's report. Different radiologists have their own way of documenting a notification. Accurately capturing each notification instance requires manual evaluation of each report, numbering up to twenty thousand per year per radiologist. Smaller practices find this overwhelming. Consequently, many opt out of QPP participation.

The claimed invention uses a combination of Natural Language Processing and Machine Learning to develop an automated data extractor to automatically evaluate unstructured reports. The claimed invention employs decision tree algorithms such as Random Trees, Bayesian algorithms, Regression algorithms, Association Rules, Neural Network and Ensemble Methods and recognize documentation of the findings required for selected MIPS measures. With training and ongoing management, AI systems can “learn” the various ways healthcare providers document findings relevant to MIPS.

As of 2017, SaferMD, LLC offers a Qualified Clinical Data Registry that includes 21 CMS approved non-MIPS measures that measure the frequency with which diagnostic providers notify referring clinicians regarding specific actionable diagnostic findings within compliance intervals defined for each respective finding. For example, measure 6 reports the proportion of radiology exams demonstrating aortic dissection in which the diagnostic provider directly notified the provider within 15 minutes of exam completion.

Using the claimed invention, a machine learning system is trained to (1) determine the presence of an actionable finding within a diagnostic report, (2) determine whether the diagnostic provider notified the referring clinician about the finding, (3) the exam completion time (4) the notification time, and (5) the interval from exam completion time and notification. Smaller practices are discouraged from participating in the Quality Payment Programs because of the cost of data extraction. A functional AI system can enable smaller practices to participate in CMS's QPP at a reasonable cost. This could dramatically increase provider participation in the program.

### DESCRIPTION OF THE FIGURES

The headings provided herein are for convenience only and do not necessarily affect the scope or meaning of the claimed invention. In the drawings, the same reference numbers and any acronyms identify elements or acts with the same or similar structure or functionality for ease of understanding and convenience. To easily identify the discussion of any particular element or act, the most significant digit or digits in a reference number refer to the Figure number in which that element is first introduced (e.g., element 101 is first introduced and discussed with respect to FIG. 1).

FIG. 1 is a schematic chart exhibiting the basic system architecture of one embodiment of the invention.

FIG. 2 is a flowchart of one embodiment of the process of medical record analysis by the invention.

FIG. 3 is a diagram showing a neural network interconnectivity.

FIG. 4 is a flowchart showing another exemplary process of the invention.

### DETAILED DESCRIPTION

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other features not described in detail herein. Additionally, some well-known structures or functions may not be shown or described in detail below, so as to avoid unnecessarily obscuring the relevant description. The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

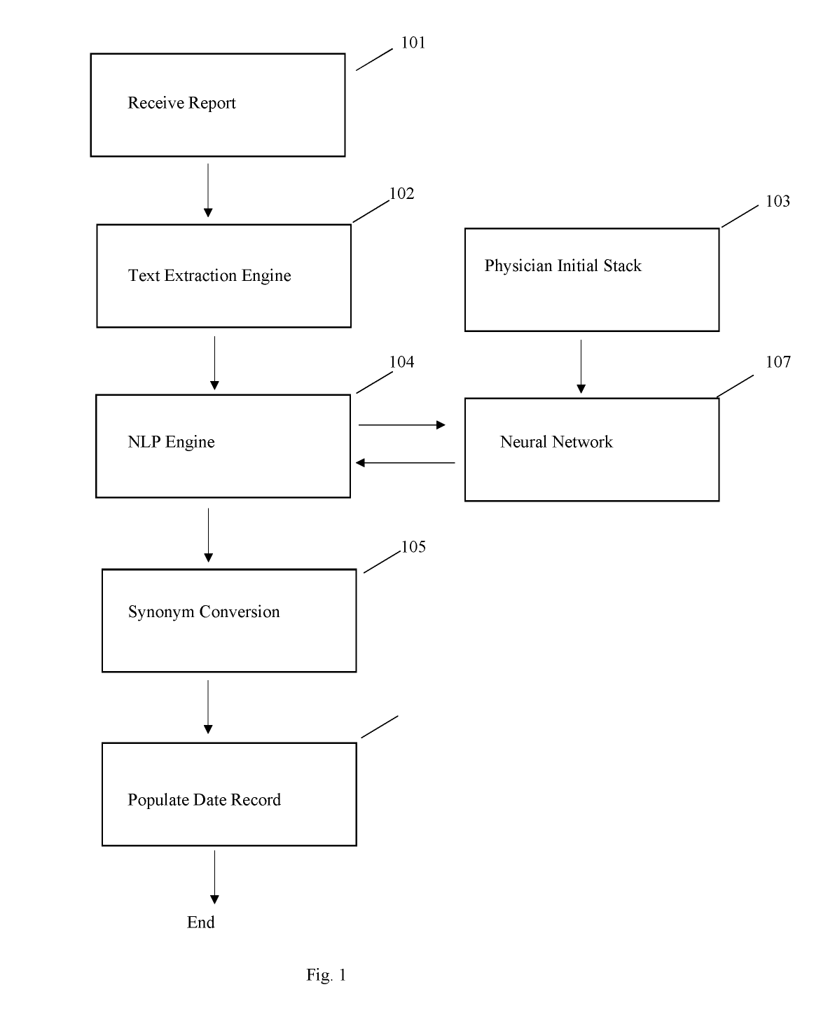

The processing of unstructured text that comprises a physician's report may utilize artificial intelligence techniques (AI). Referring to FIG. 1., a report is received by the system (101). If an image, rather than text, the step (102) may include converting the image into text. In this case, an AI engine of a neural network may be used to interpret the image in order to extract the text. In addition, if the report is hand-written, the same may apply. The text, being unstructured, is automatically analyzed in order to determine critical test result data that is then used to populate a data record in a structured way (106). Thus, the output is a data record corresponding to the report where the important features of the report populate the data record as data elements. For example, the data record may include a transmission time stamp, a retrieval time stamp, a diagnosis identification entry, and a recommendation entry. In order to convert the unstructured text, the system utilizes a natural language programming (NLP) engine at step 104. This engine utilizes AI techniques, including a neural network, to review the text to identify a critical diagnosis. Use of a standard parser may be utilized, but because many reports are written using unstructured phrases, this may be inadequate. Instead, a neural network (107) may be used to identify text that indicates a critical diagnosis. In one example, presented as illustration, the neural network may be trained with a corpus of documents that are reports from a given physician. This corpus can be used to populate the neural network with rules, coefficients, or other initialization data that identify for that physician, phrases that are highly likely to indicate a diagnosis or other features of the report. This way, the neural network may be customized for each physician in order to increase its accuracy. For each physician, there may be a set of rules, coefficients, or other initializing information, including definitions of hidden layers in the network, that sets up the neural network to analyze that physician's reports. (103). When that physician is identified by the system as the reviewer of a test, then the system selects that initialization stack (103) to operate the neural network. Further, the system may identify a diagnosis, but detect the words used in a way that is not standard. For example, a physician may refer to unknown features in an image as a “mass” while the standard phraseology may be “nodule”. The neural network may therefore categorize a text “mass” as the diagnosis, but that may not be sufficient from an output standpoint. Therefore, a synonym conversion step may apply (105), that converts the identified subject matter of a diagnosis to a standard word. In other embodiments, the synonym conversion can be incorporated into the neural network, where a synonym table is introduced as input into the network as part of the training and as part of the initial stack. Once the critical diagnosis is determined from analysis of the report, a data record may be populated with this information (106).

In other embodiments, the system may identify text it considers relevant, but may not have sufficient confidence in the result, based on the operation of the neural network rules. When that occurs, the system can then initiate (or queue for initiation) an interaction with a human operator that can input data indicating the proper result. This can then be used to update the initial stack (103) for that physician. Other embodiments can be sufficiently trained using a wider corpus of reports from a wide range of physicians to have a neural network that is the same for all reports from all the physicians. Alternatively, an initial stack for populating or initializing a neural network may be associated with the subject area of the report. For example, radiological review may utilize a different neural network than that utilized for analyzing reports from a pathologist. The two fields may involve training using different corpus', thus requiring the initial stack (103) for populating the neural network to be selected based on subject matter of the report.

In yet another embodiment, the neural network has to select the text item that it considers likely to be the “DIAGNOSIS”, and its location. Thus, in the example given, the output of the system would be “Diagnosis: Mass, Thyroid. With the synonym conversion, it becomes DIAGNOSIS: Nodule, Thyroid. Similarly, the output would categorize the patient: SEX: Male, AGE: 78, STATUS: Poor, HISTORY: etc. In other words, rather than categorizing what the unstructured text is about (a medical report), the neural network is identifying the most relevant text fragments and determining whether the fragment is a description of one of a set of predetermined types of information, or features: DIAGNOSIS, SEX, AGE, STATUS or HISTORY. Other features include: an alphanumeric string representing the examination completion date and time, a logic value representing whether healthcare service provider notified the referring clinician about the finding, a string representing the delivery date/time of the notification, a value representing the time period between the examination date and time and the notification date and time and an alphanumeric string representing a healthcare action.

One way the system can select an initial stack for the neural network is to use text matching to identify the text indicating the physician's name, and then use that determination for the selection of the initial stack. In another embodiment, the neural network can use one initial stack to identify the general subject matter of the report, for example, radiology vs. pathology, and then re-initialize the neural network for that type of report.

A neural network can be thought of as a a series of layers of interconnected “neurons” (modelled numerically by programming code), each neuron simulated by a simple linear equation:

$$output = \{ \begin{matrix}0 if w * x + b \leq 0 \\ 1 if w * x + b > 0\end{matrix}$$

For a multiple input neuron, w and x are vectors whose elements are the weights and input values and their product is a dot product:

\vec{ω}·\vec{x}≡Σⱼωⱼxⱼ

The weight vector w represents the strength of each of the one or more inputs to the neuron. The input vector x represents the corresponding one or more inputs to the neuron. When the dot product of the two vectors is above or below a threshold b, the output of the neuron is a 1, or alternatively, a 0. The polarity of b and the sense of the inequality can be reversed with the same basic logic working. In this specification and in the claims it is assumed that “above threshold” means any arrangement of b, the minus or plus sign before it and the corresponding sense of “less than” or “greater than” that follows. Note that the equation for the neuron is exemplary, other forms, for example a sigmoid neuron model may be used.

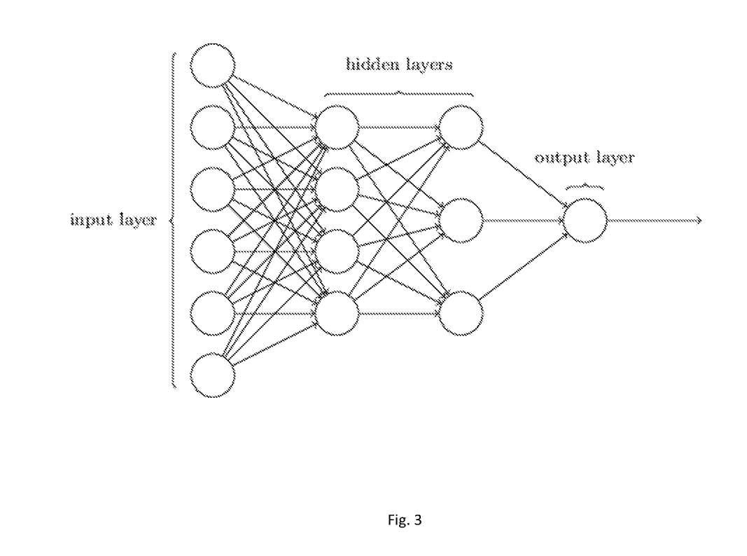

The neural network may have one or more layers where the output of one neuron feeds one or more inputs at the next layer, and so on, until there is a layer that feeds one neuron that outputs a result. FIG. 3 depicts an exemplary neural network, where the circles represent the neurons and the arrows the connection of the inputs and outputs. In some embodiments, there are more than one output neurons, especially where the output of the entire neural network program, where the set of output neurons represent an output vector. It is also important to note that the neural network may have different topologies of how one layer of neurons connect to the next, and how many layers there are. This specification of interconnectivity may be varied to balance compute load and accuracy of the result. Where the mathematics is presented by way of explanation, an embodiment of the invention is a computer system comprised of logic that executes program steps that perform these calculations for each neuron in the network in the proper sequence.

The important feature of a neural network is how it is “trained” in order that the weight vectors and threshold vectors be determined. A process is used to find weights and thresholds so that the output from the network approximates the desired output function for a predetermined training input data set for inputs x. This is done by using an error or cost function. This function's value represents a distance of the output vector a of the network from the desired output for a given training input x. An example cost function is provided below:

$$C ( w , b ) ≡ \frac{1}{2 n} {\sum }_{i = 1}^{n} {‖ y ( {x}_{i} ) - a ‖}^{2}$$

Here, w denotes the collection of weights in the network, b the thresholds, n is the total number of training input vectors x, a is the vector of the desired output from the network when x is input, y is the neural network output when an input x is applied and the sum is over all training input vectors, x. The cost function output a depends on x, w and b and the input training set x, the desired output a and the neural network function y. In this embodiment the cost function is a quadratic function, but other cost functions may be used. The optimization process seeks to find weights and thresholds that minimize the cost function C(w,b) for given set of input vectors, x. This may be achieved in a number of ways, that is various hill climbing (or valley finding) algorithms may be used. In one embodiment, an algorithm repeatedly computes the gradient of C, starting at a predetermined point along the hypersurface of C and then using that local gradient to select a next point, that is, a revised set of w and b values, and recalculating the gradient in order to move again. The peak (or valley) is identified when the gradient value for any neighboring points goes the wrong way. The idea is to use gradient descent to find the weights and thresholds which minimize the cost equation for a given training input set, x for its corresponding desired output a. There are various ways to compute the gradient of C. One algorithm calculates an error function starting at the output layer and working backwards towards the first input layer. Once the optimized cost function has determined the weights and thresholds, the neural network is trained.

Use of a neural network as part of the invention requires using training on a predetermined input training data set (x, a) in order to determine a set of parameters that define the interconnectivity, weights and thresholds of a given network for a given data processing task. The invention is embodied by several tasks. First is feature extraction from the reports generated by physician or other healthcare personnel. From these features, the network can be trained to extract a predetermined feature set from each report, for example, a diagnosis, an examination date, a reporting date, a transmission date, a reading date. In some cases, the dates may be trivially determined using computer logic that parses a data record and finds the information in the appropriate places in a data structure. In other cases, the physician has written this information down in prose, in which case, the neural network is trained to obtain that information and populate a data structure associated with the analyzed report, storing the recovered information in the appropriate locations in the data structure for that report. The finished data structure may be stored in a data base as a data record or in the form of relational tables.

Extracting the diagnosis may be more complex. The neural network design and training for any possible diagnosis input may be too complex. By way of example, the word “lump” may have different interpretations, whether in a report by an oncologist (i.e. a tumor), versus a gastroenterologist (“the patient vomited lumps.”) The former may be a diagnosis, the latter a symptom. This distinction may mean that the parameters loaded into a neural network may be dependent on the specific context of its application when processing the medical report data. Efficiencies may be accomplished by training the neural network to produce a parameter set that is physician specific, that is, trained to interpret a particular physician's reporting, that is practice specific, that is trained to interpret reporting from a particular medical or healthcare service practice, or domain specific, that is, trained to interpret a particular category of medical or healthcare service.

In the case of the physician specific, a training data set may be used where the physician's past reporting is the input into the system, and the known diagnosis (or other desired output) is the target output. The optimization process may be conducted to determine the parameters that provide the most accurate analysis for reports from that physician. This parameter set may be stored in a data file on a mass storage device, with an indexing system that associates a physician identifier with that parameter set, also referred to as the stack. In this embodiment, when the invention detects the specific physician's identifier on a report, it loads the neural network parameters, or stack, associated with that physician. Likewise, a training data set may be used that encompasses reports from an entire medical or healthcare practice. When the system detects a report that has an identifier associated with that healthcare service, it loads the corresponding parameter set into the neural network in order to analyze the report. More broadly, a training set of reports that are related by the medical or healthcare domain may be used. In this case, a training data set may be predetermined to be associated with a particular field, for example, cardiology, or oncology, or a subfield, for example, breast cancer. In this embodiment, when the system detects that the subject matter of the report is in that field, the associated parameter set for that context is loaded into the neural network to process that report. In one embodiment, the field context may be determined based on the identity of the physician or healthcare provider. For example, the physician identifier can be used by the system to poll a database that delivers the specialty value for the physician. For example, Dr. Marcus Welby, may have an identifier that is used by the system to submit a query to the data base to recover a text string encoding his specialty: cardiology. Having identified that specialty, the system can use that to map to a file or files containing the parameters or stack associated with the cardiology domain. These are loaded into computer memory in order to initialize a neural network optimized for analyzing cardiology reports. Having initialized the neural net, the report itself is input into the neural network so that the network may identify the predetermined report parameters that are sought to be extracted.

In yet another embodiment, the system can use other heuristics to identify the context of a medical report. In one embodiment of a heuristic, a report can be analyzed to find keyword frequencies. Typically, the top one or two keywords in frequency can identify the context. For example, a report that the logic determined uses the word “tumor” 20 times, while the term “serum level” is used once, is more likely related to cancer (oncology), than cardiology. Having made this determination, the system can select the oncology parameters to be loaded into the neural network to process that report.

### CMS Quality Payment Program Measures

Under the Medicare Access and CHIP Reauthorization Act (MACRA), Quality Payment Program (QPP) and the Merit Incentive Payment Program (MIPS) healthcare providers are required to report adherence to best practices and relative performance with respect to CMS authorized measures. Providers must report quality measures on at least 60% of their activities during calendar year 2018. While some quality measures ask whether the provider performed specific procedures, more complex measures ask “how” procedures were performed. In the latter case, some of the required documentation comes from providers' notes or reports. These documents are often written in an unstructured manner that makes it difficult to find the relevant data. Healthcare providers do not write using uniform a lexicon. One radiologist may document a thyroid “mass”, while another radiologist may describe the same thyroid finding as a “nodule”.

The challenge may be understood by looking at a relevant measure. Quality Measure #406 asks for the “Percentage of final reports for computed tomography (CT), CT angiography (CTA) or magnetic resonance imaging (MRI) or magnetic resonance angiogram (MRA) studies of the chest or neck or ultrasound of the neck for patients aged 18 years and older with no known thyroid disease with a thyroid nodule <1.0 cm noted incidentally with follow-up imaging recommended.” In one embodiment, to calculate the ratio specified in this measure, one must extract the following data elements from the exams interpreted by a given provider over a specified time interval:
1—Was the exam either a CT, CTA or MRI exams of the chest or neck
2—Was the patient 18 years or older?
3—Did the patient have a history of thyroid disease?
4—Was there a thyroid nodule measuring up to one centimeter?
5—Did the interpreting radiologist recommend a follow up imaging exam for further evaluation of the nodule?

In the report example at the end of this description, the necessary data elements are evident:
1—The exam was a neck MRA
2—The patient is more than 18 years old
3—No history of thyroid disease
4—There is a thyroid nodule measuring less than one centimeter
5—The radiologist recommended imaging follow up to further characterize the nodule.

another embodiment, the system will identify 60% of the total procedure volume with In the highest ratio of compliance. The procedure steps are:
Quantify the total procedure volume
Calculate 60% of the procedure volume
Identify a list of procedures that includes 60% of the total volume
   Include compliant procedures first
   Add enough non-compliant procedures to bring the list total to 60% of the total procedure volume.

In another embodiment: the system will identify procedures that should be excluded from the denominator and numerator, if the procedure meets the measure specification for denominator exclusion.

Input:
Multiple reports may be input to the extraction system in several ways: JSON file, spreadsheet, XML, as separate files in a specified folder, or as a single composite PDF.

Output:
The extracted data for each exam could be delivered in several formats:
   Spreadsheet with one row for each exam meeting the selection criteria, and fields for each data element
   Spreadsheet with one row for each exam meeting the selection criteria, and paired fields for each data element. The first field contains the score. The second fields contains the % calculated confidence for the score.
   Text indicating the number of relevant exams, and the percentage in which the radiologist recommended imaging exam follow up.
   a data record populated with the information.

### Radiology Report Example

In yet another embodiment, an example report specifies a sub-centimeter thyroid nodules+recommending imaging follow up, as indicated below.

St. Elsewhere Hospital Columbia, Mo.

### Department of Radiology

### BERLIN, IRMA MAY

### Ordering MD: WELBY,MARCUS MD

### MRN: 12406893

### Acct: 000017761492

### DOB: 09/11/1963

### Pt Type: OPD

### Sex: F

### Ord Site: CLINIC Z

### Study Date 03/03/17

### Accession #0828-0079

### Procedure Code 48792

### Procedure CTA Neck

### *** Signed ***

EXAMINATION: CT Angiography neck
CLINICAL HISTORY: Carotid stenosis. Hypertension. Hyperlipidemia. Headaches.
COMPARISON: Outside CT chest 5/7/2012 done at SPMC.
TECHNIQUE: CT angiography of the neck was performed after uneventful intravenous injection of 75 mL Isovue-370. Internal carotid stenosis measured according to NASCET criteria. Axial and multiplanar MIP images were reformatted and reviewed. Additional 3-D reconstructions and postprocessing were performed independently by the attending radiologist and a separate dedicated 3-D workstation. A dose lowering technique was used for this procedure, which may include, but is not limited to, dose reduction technique, automated exposure control, the use of iterative reconstruction, and ALARA (As Low As Reasonably Achievable)/Image Gently techniques.
FINDINGS: Somewhat large field-of-view which limits detail.

### CTA NECK FINDINGS:

Aorta and great vessel origins: Classic 3 vessel aortic arch origin anatomy. Prominent atherosclerotic calcifications and plaque noted along the arch and proximal mediastinal vessels. Severe stenosis proximal left subclavian artery.

Right carotid artery: Mixed predominantly calcific plaque noted at the right carotid bifurcation and bulb, with less than 50% stenosis of the proximal right cervical ICA/bulb. Prominent tortuosity with associated kinking of the cervical ICA.

Left carotid artery: Mild to moderate mixed but predominantly calcific plaque noted at the left carotid bifurcation and bulb. Left carotid bulb caliber narrows to 2 mm, relative to a superior nondiseased caliber of 4.5 mm, consistent with approximately 55% stenosis. Prominent tortuosity with associated kinking of the cervical ICA.

Vertebral arteries: Moderate to severe narrowing both vertebral artery origins, left worse than right. Somewhat tortuous bilateral vertebral artery V2 segments. No additional focal significant stenosis in the neck. Possible tiny inferiorly projecting aneurysm off of the left cavernous ICA. Possible small medially projecting aneurysm right cavernous/supraclinoid ICA junction. Long segment atherosclerotic calcifications of the cavernous and proximal supraclinoid ICA segments without significant stenosis. Proximal portions of the anterior and middle cerebral arteries are patent. ACOM not well visualized. Posterior circulation is codominant. Mild atherosclerotic calcification vertebral artery V4 segments. These artery without focal stenosis to the terminus. Fetal configuration of the right PCA with a hypoplastic P1 segment and patent PCOM. Left posterior cerebral artery patent. Possible left PCOM infundibulum. Proximal portions of the superior cerebellar arteries and AICA/PICA loops patent. SOFT TISSUES: Age-appropriate prominence of the ventricles and extra-axial/subarachnoid spaces. Prior lens replacements. Streak artifact from dental amalgam partially obscures assessment. Periodontal lucency and decay. Asymmetric prominence right palatine tonsil. Subcentimeter low-attenuation right thyroid nodule suggested. Suspicious for an underlying mass. Could consider short interval follow-up CT in 3 months, PET, or biopsy.

IMPRESSION: 1. No evidence of hemodynamically significant stenosis in the neck.
Approximately 55% stenosis left carotid bulb.
2. Severe atherosclerotic narrowing proximal left subclavian artery.
3. Additional multifocal intracranial and extracranial atherosclerotic disease as above.
4. Possible bilateral tiny cavernous ICA segment aneurysms.
5. Sub-centimeter right thyroid mass. Appearance is concerning for potential underlying neoplasm. Imaging recommendations include either follow-up CT in 3 months, PET, or biopsy.
A Incidental message has been communicated to TERRENCE SCOTT via the PowerScribe 360|
Critical Result system on 3/3/2017 10:07 AM, Message ID 1984723.

### Electronically Signed By: GALBRAITH,JOHN MD 03/03/17 1112

### Dictated On: 03/03/17 1011

### Interpreted By: GALBRAITH,JOHN MD

### Transcribed On: 03/03/17 1011—JY

### CC: LINKLETTER, ART MD

As shown in the report, the difference between the study date and date of birth indicates that the participant's age is 53.

The most important component is that the clinical history field does not disclose a history of thyroid cancer. Yet, the findings field discloses a subcentimeter low-attenuation right thyroid nodule. The impression is that the sub-centimeter right thyroid mass is “concerning,” and the recommendation is for a follow-up appointment in three months. This information can be used to train a neural network to identify a diagnosis of “tumor”, location of “thyroid” and treatment order: “follow up 3 months.”

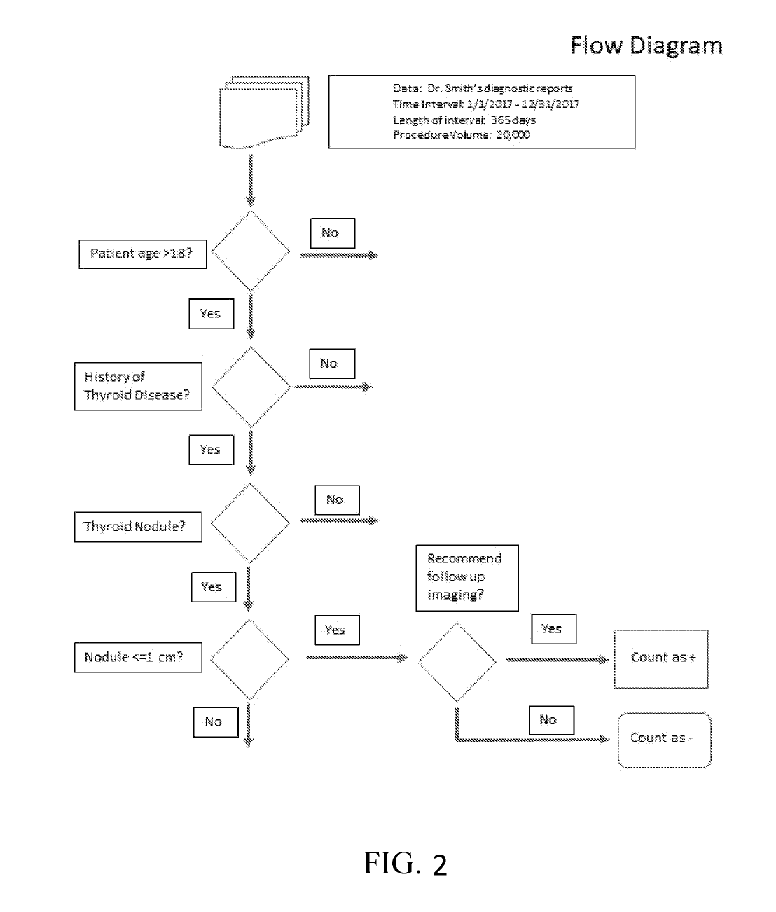

FIG. 2 depicts another embodiment of the invention. In this embodiment, the medical record is input into the system and one or more features are identified. In this embodiment, the system can implement logic that expresses conditionals that query the feature set in order to progress through a predetermined logic process to determine whether the medical record is relevant or not, and if relevant, how to tally the record. In this example, the medical record is not relevant unless the “diagnosis” feature is equal to “thyroid nodule”, and if so, whether the “order” feature is equal to “follow-up imaging”. When the logic detects that it is, it increments a data value in memory of a correct outcome for that diagnosis type. When the logic detects that it is not, it is not incremented. In this way, the extracted feature set can be used to drive further analysis of the data records to tally a percentage of correct orders for a particular type of diagnosis. The specific logic may be predetermined for each type of diagnosis. In this way, the logic may be arranged that the diagnosis feature is used to select by logic a further logic pathway for the service quality measurement.

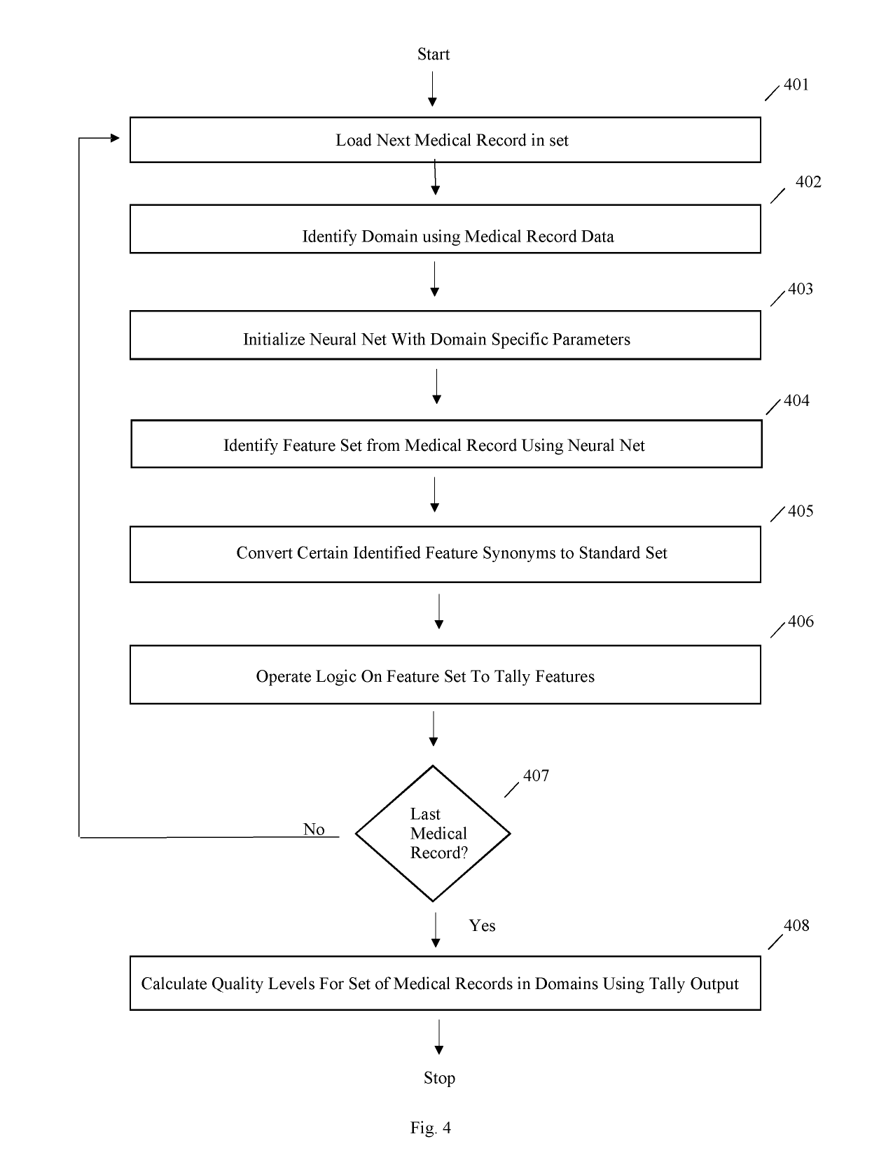

FIG. 4 depicts a flowchart of an embodiment of the invention. First, a set of medical records is input into the system. These may be data records in a data base or a set of data files.

The process starts with fetching the next medical record (401), which means loading into computer from mass storage a data record constituting medical record. This may be by populating by means of a parser a data structure in memory with structured data, and parts of the data structure with unstructured data, that is, prose descriptions of an examination or test result review. The system then uses an element of the data structure as input to the step of determining the applicable service domain (402), or alternatively, the healthcare practitioner, or service. This may be as simple as using a physician identifier obtained from parsing the structured data and mapping that to a domain using a database that relates personnel to their respective medical domains. The system can then use the identified domain data as input into logic that obtains associated feature set data parameters stored in a data file to load the applicable domain specific parameters for that medical domain and thereby initialize a neural network instance. (403) The neural network can then be fed data comprising the medical report as input. The neural network can identify one or more features set items associated with a particular measure, which may be output as text items. (404). In addition, a synonym process associated with the neural network or incorporated within its processes can convert specific labels to a standard or predetermined set as alphanumeric text output. (405) This data may be used as input to tally logic in order to tallly certain aspects of the identified features set (406). Once the last medical record is processed (407), a quality level data value can be calculated using the tally data as input. (408). In another embodiment the quality level for any of the domains in the set of records is tallied independently. In this way, a set of medical records from two or more different domain specialties can be processed at the same time.

The foregoing description discloses only exemplary embodiments of the invention. Modifications of the above disclosed apparatus and methods which fall within the scope of the invention will be readily apparent to those of ordinary skill in the art. Accordingly, while the present invention has been disclosed in connection with exemplary embodiments thereof, it should be understood that other embodiments may fall within the spirit and scope of the invention as defined by the following claims.

### Operating Environment:

The system is typically comprised of a central server that is connected by a data network to a user's computer. The central server may be comprised of one or more computers connected to one or more mass storage devices. The precise architecture of the central server does not limit the claimed invention. Further, the user's computer may be a laptop or desktop type of personal computer. It can also be a cell phone, smart phone or other handheld device, including a tablet. The precise form factor of the user's computer does not limit the claimed invention. Examples of well-known computing systems, environments, and/or configurations that may be suitable for use with the invention include, but are not limited to, personal computers, server computers, hand-held computers, laptop or mobile computer or communications devices such as cell phones, smart phones, and PDA's, multiprocessor systems, microprocessor-based systems, set top boxes, programmable consumer electronics, network PCs, minicomputers, mainframe computers, distributed computing environments that include any of the above systems or devices, and the like. Indeed, the terms “computer,” “server,” and the like may be used interchangeably herein, and may refer to any of the above devices and systems.

The user environment may be housed in the central server or operatively connected to it remotely using a network. In one embodiment, the user's computer is omitted, and instead an equivalent computing functionality is provided that works on a server. In this case, a user would log into the server from another computer over a network and access the system through a user environment, and thereby access the functionality that would in other embodiments, operate on the user's computer. Further, the user may receive from and transmit data to the central server by means of the Internet, whereby the user accesses an account using an Internet web-browser and browser displays an interactive web page operatively connected to the central server. The server transmits and receives data in response to data and commands transmitted from the browser in response to the customer's actuation of the browser user interface. Some steps of the invention may be performed on the user's computer and interim results transmitted to a server. These interim results may be processed at the server and final results passed back to the user.

The Internet is a computer network that permits customers operating a personal computer to interact with computer servers located remotely and to view content that is delivered from the servers to the personal computer as data files over the network. In one kind of protocol, the servers present webpages that are rendered on the customer's personal computer using a local program known as a browser. The browser receives one or more data files from the server that are displayed on the customer's personal computer screen. The browser seeks those data files from a specific address, which is represented by an alphanumeric string called a Universal Resource Locator (URL). However, the webpage may contain components that are downloaded from a variety of URL's or IP addresses. A website is a collection of related URL's, typically all sharing the same root address or under the control of some entity. In one embodiment different regions of the simulated space displayed by the browser have different URL's. That is, the webpage encoding the simulated space can be a unitary data structure, but different URL's reference different locations in the data structure. The user computer can operate a program that receives from a remote server a data file that is passed to a program that interprets the data in the data file and commands the display device to present particular text, images, video, audio and other objects. In some embodiments, the remote server delivers a data file that is comprised of computer code that the browser program interprets, for example, scripts. The program can detect the relative location of the cursor when the mouse button is actuated, and interpret a command to be executed based on location on the indicated relative location on the display when the button was pressed. The data file may be an HTML, document, the program a web-browser program and the command a hyper-link that causes the browser to request a new HTML document from another remote data network address location. The HTML can also have references that result in other code modules being called up and executed, for example, Flash or other native code.

The invention may also be entirely executed on one or more servers. A server may be a computer comprised of a central processing unit with a mass storage device and a network connection. In addition a server can include multiple of such computers connected together with a data network or other data transfer connection, or, multiple computers on a network with network accessed storage, in a manner that provides such functionality as a group. Practitioners of ordinary skill will recognize that functions that are accomplished on one server may be partitioned and accomplished on multiple servers that are operatively connected by a computer network by means of appropriate inter process communication. In addition, the access of the web site can be by means of an Internet browser accessing a secure or public page or by means of a client program running on a local computer that is connected over a computer network to the server. A data message and data upload or download can be delivered over the Internet using typical protocols, including TCP/IP, HTTP, TCP, UDP, SMTP, RPC, FTP or other kinds of data communication protocols that permit processes running on two respective remote computers to exchange information by means of digital network communication. As a result a data message can be one or more data packets transmitted from or received by a computer containing a destination network address, a destination process or application identifier, and data values that can be parsed at the destination computer located at the destination network address by the destination application in order that the relevant data values are extracted and used by the destination application. The precise architecture of the central server does not limit the claimed invention. In addition, the data network may operate with several levels, such that the user's computer is connected through a fire wall to one server, which routes communications to another server that executes the disclosed methods.

The invention may also be practiced in distributed computing environments where tasks are performed by remote processing devices that are linked through a communications network. In a distributed computing environment, program modules may be located in both local and remote computer storage media including memory storage devices. Practitioners of ordinary skill will recognize that the invention may be executed on one or more computer processors that are linked using a data network, including, for example, the Internet. In another embodiment, different steps of the process can be executed by one or more computers and storage devices geographically separated by connected by a data network in a manner so that they operate together to execute the process steps. In one embodiment, a user's computer can run an application that causes the user's computer to transmit a stream of one or more data packets across a data network to a second computer, referred to here as a server. The server, in turn, may be connected to one or more mass data storage devices where the database is stored. The server can execute a program that receives the transmitted packet and interpret the transmitted data packets in order to extract database query information. The server can then execute the remaining steps of the invention by means of accessing the mass storage devices to derive the desired result of the query. Alternatively, the server can transmit the query information to another computer that is connected to the mass storage devices, and that computer can execute the invention to derive the desired result. The result can then be transmitted back to the user's computer by means of another stream of one or more data packets appropriately addressed to the user's computer. In one embodiment, a relational database may be housed in one or more operatively connected servers operatively connected to computer memory, for example, disk drives. In yet another embodiment, the initialization of the relational database may be prepared on the set of servers and the interaction with the user's computer occur at a different place in the overall process.

The method described herein can be executed on a computer system, generally comprised of a central processing unit (CPU) that is operatively connected to a memory device, data input and output circuitry (TO) and computer data network communication circuitry. Computer code executed by the CPU can take data received by the data communication circuitry and store it in the memory device. In addition, the CPU can take data from the I/O circuitry and store it in the memory device. Further, the CPU can take data from a memory device and output it through the IO circuitry or the data communication circuitry. The data stored in memory may be further recalled from the memory device, further processed or modified by the CPU in the manner described herein and restored in the same memory device or a different memory device operatively connected to the CPU including by means of the data network circuitry. The CPU may perform logic comparisons of one or more of the data items stored in memory or in the cache memory of the CPU, or perform arithmetic operations on the data in order to make selections or determinations using such logical tests or arithmetic operations. The process flow may be altered as a result of such logical tests or arithmetic operations so as to select or determine the next step of a process. The memory device can be any kind of data storage circuit or magnetic storage or optical device, including a hard disk, optical disk or solid state memory. The IO devices can include a display screen, loudspeakers, microphone and a movable mouse that indicate to the computer the relative location of a cursor position on the display and one or more buttons that can be actuated to indicate a command.

The computer can display on the display screen operatively connected to the I/O circuitry the appearance of a user interface. Various shapes, text and other graphical forms are displayed on the screen as a result of the computer generating data that causes the pixels comprising the display screen to take on various colors and shades or brightness. The user interface may also display a graphical object referred to in the art as a cursor. The object's location on the display indicates to the user a selection of another object on the screen. The cursor may be moved by the user by means of another device connected by I/O circuitry to the computer. This device detects certain physical motions of the user, for example, the position of the hand on a flat surface or the position of a finger on a flat surface. Such devices may be referred to in the art as a mouse or a track pad. In some embodiments, the display screen itself can act as a trackpad by sensing the presence and position of one or more fingers on the surface of the display screen. When the cursor is located over a graphical object that appears to be a button or switch, the user can actuate the button or switch by engaging a physical switch on the mouse or trackpad or computer device or tapping the trackpad or touch sensitive display. When the computer detects that the physical switch has been engaged (or that the tapping of the track pad or touch sensitive screen has occurred), it takes the apparent location of the cursor (or in the case of a touch sensitive screen, the detected position of the finger) on the screen and executes the process associated with that location. As an example, not intended to limit the breadth of the disclosed invention, a graphical object that appears to be a two dimensional box with the word “enter” within it may be displayed on the screen. If the computer detects that the switch has been engaged while the cursor location (or finger location for a touch sensitive screen) was within the boundaries of a graphical object, for example, the displayed box, the computer will execute the process associated with the “enter” command. In this way, graphical objects on the screen create a user interface that permits the user to control the processes operating on the computer.

In some instances, especially where the user computer is a mobile computing device used to access data through the network the network may be any type of cellular, IP-based or converged telecommunications network, including but not limited to Global System for Mobile Communications (GSM), Time Division Multiple Access (TDMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), Worldwide Interoperability for Microwave Access (WiMAX), Universal Mobile Telecommunications System (UMTS), Evolution-Data Optimized (EVDO), Long Term Evolution (LTE), Ultra Mobile Broadband (UMB), Voice over Internet Protocol (VoIP), Unlicensed Mobile Access (UMA), any form of 802.11.xx or Bluetooth.

Computer program logic implementing all or part of the functionality previously described herein may be embodied in various forms, including, but in no way limited to, a source code form, a computer executable form, and various intermediate forms (e.g., forms generated by an assembler, compiler, linker, or locator.) Source code may include a series of computer program instructions implemented in any of various programming languages (e.g., an object code, an assembly language, or a high-level language such as C, C++, C#, Action Script, PHP, EcmaScript, JavaScript, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The invention may be described in the general context of computer-executable instructions, such as program modules, being executed by a computer. Generally, program modules include routines, programs, objects, binary components that, when executed by the CPU, perform particular tasks or implement particular abstract data types and when running, may generate in computer memory or store on disk, various data structures. A data structure may be represented in the disclosure as a manner of organizing data, but is implemented by storing data values in computer memory in an organized way. Data structures may be comprised of nodes, each of which may be comprised of one or more elements, encoded into computer memory locations into which is stored one or more corresponding data values that are related to an item being represented by the node in the data structure. The collection of nodes may be organized in various ways, including by having one node in the data structure being comprised of a memory location wherein is stored the memory address value or other reference, or pointer, to another node in the same data structure. By means of the pointers, the relationship by and among the nodes in the data structure may be organized in a variety of topologies or forms, including, without limitation, lists, linked lists, trees and more generally, graphs. The relationship between nodes may be denoted in the specification by a line or arrow from a designated item or node to another designated item or node. A data structure may be stored on a mass storage device in the form of data records comprising a database, or as a flat, parsable file. The processes may load the flat file, parse it, and as a result of parsing the file, construct the respective data structure in memory. In other embodiment, the data structure is one or more relational tables stored on the mass storage device and organized as a relational database.

The computer program and data may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed hard disk), an optical memory device (e.g., a CD-ROM or DVD), a PC card (e.g., PCMCIA card, SD Card), or other memory device, for example a USB key. The computer program and data may be fixed in any form in a signal that is transmittable to a computer using any of various communication technologies, including, but in no way limited to, analog technologies, digital technologies, optical technologies, wireless technologies, networking technologies, and internetworking technologies. The computer program and data may be distributed in any form as a removable storage medium with accompanying printed or electronic documentation (e.g., a disk in the form of shrink wrapped software product or a magnetic tape), preloaded with a computer system (e.g., on system ROM or fixed disk), or distributed from a server, website or electronic bulletin board or other communication system (e.g., the Internet or World Wide Web.) It is appreciated that any of the software components of the present invention may, if desired, be implemented in ROM (read-only memory) form. The software components may, generally, be implemented in hardware, if desired, using conventional techniques.

It should be noted that the flow diagrams are used herein to demonstrate various aspects of the invention, and should not be construed to limit the present invention to any particular logic flow or logic implementation. The described logic may be partitioned into different logic blocks (e.g., programs, modules, functions, or subroutines) without changing the overall results or otherwise departing from the true scope of the invention. Oftentimes, logic elements may be added, modified, omitted, performed in a different order, or implemented using different logic constructs (e.g., logic gates, looping primitives, conditional logic, and other logic constructs) without changing the overall results or otherwise departing from the true scope of the invention. Where the disclosure refers to matching or comparisons of numbers, values, or their calculation, these may be implemented by program logic by storing the data values in computer memory and the program logic fetching the stored data values in order to process them in the CPU in accordance with the specified logical process so as to execute the matching, comparison or calculation and storing the result back into computer memory or otherwise branching into another part of the program logic in dependence on such logical process result. The locations of the stored data or values may be organized in the form of a data structure.

The described embodiments of the invention are intended to be exemplary and numerous variations and modifications will be apparent to those skilled in the art. All such variations and modifications are intended to be within the scope of the present invention as defined in the appended claims. Although the present invention has been described and illustrated in detail, it is to be clearly understood that the same is by way of illustration and example only, and is not to be taken by way of limitation. It is appreciated that various features of the invention which are, for clarity, described in the context of separate embodiments may also be provided in combination in a single embodiment. Conversely, various features of the invention which are, for brevity, described in the context of a single embodiment may also be provided separately or in any suitable combination. It is appreciated that the particular embodiment described in the Appendices is intended only to provide an extremely detailed disclosure of the present invention and is not intended to be limiting.

The foregoing description discloses only exemplary embodiments of the invention.

Modifications of the above disclosed apparatus and methods which fall within the scope of the invention will be readily apparent to those of ordinary skill in the art. Accordingly, while the present invention has been disclosed in connection with exemplary embodiments thereof, it should be understood that other embodiments may fall within the spirit and scope of the invention as defined by the following claims.

What is claimed:

1. A system for determining data representing a diagnosis from a medical report text data object comprising:
A module adapted by logic to embody a neural network adapted to receive as input the medical report data object and identify a predetermined feature alphanumeric text string by using a predetermined parameter set to initialize the neural network;
a module configured by logic to populate a data record associated with the medical report with the identified feature alphanumeric text string and to store the data record in a database.

2. The system of claim 1 where the predetermined feature is one of: a diagnosis, a location, an examination date, a reporting date, a transmission date, a receiving date, a reading date, a sex, an age, a status, a history, and an order.

3. The system of claim 1 where the initializing parameter set is derived from operating an optimization process on a predetermined set of medical records with a known feature text string where such medical records correspond to at least one of: a predetermined healthcare service person, a predetermined healthcare service, a predetermined healthcare domain, a predetermined healthcare sub-domain.

4. The system of claim 1 further comprising a module adapted by logic to determine a text string representing a synonym for the predetermined feature text string and to output the alphanumeric text string representing the synonym for the system to use to populate the data record.

5. The system of claim 1 further comprising a module adapted by logic to analyze the medical record input to determine a one of a plurality of parameters sets to use as the parameter set to initialize the neural network.

6. The system of claim 5 where the module is further configured by logic to determine one of: a physician identity, a healthcare service person identity, a healthcare service identity, a healthcare domain identity and a healthcare sub-domain identity, and to use the determined identity to select the parameter set.

7. The system of claim 5 further comprising a module adapted by logic to determine a text string representing a synonym for the predetermined feature text string and to output the alphanumeric text string representing the synonym for the system to use to populate the data record.

8. The system of claim 2 further comprising:
A module adapted by logic to use the identified feature to select a corresponding tally logic for that feature type;
a module adapted by logic to execute the tally logic using a second identified feature extracted from the medical record object and update a tally value.

9. The system of claim 8 further comprising a module adapted by logic to calculate a quality level for the identified feature using the updated tally value.

10. The system of claim 1 where the detected feature is one of: an alphanumeric string representing the examination completion date and time, a logic value representing whether healthcare service provider notified the referring clinician about the finding, a string representing the delivery date/time of the notification, a value representing the time interval between the examination date and time and the notification date and time and an alphanumeric string representing a healthcare action.

11. The system of claim 10 where the time interval is not detected by the neural network but directly calculated using the logic and the detected features as input to the calculation.

12. A method for determining data representing a diagnosis from a medical report text data object comprising:
initializing a neural network using a predetermined parameter stack;
receiving at the input layer of the neural network data representing the medical report data object;
using the neural network to identify at least one predetermined feature alphanumeric text string;
populating a data record associated with the medical report with the at least one identified feature alphanumeric text string; and
storing the data record in a database.

13. The method of claim 12 further comprising:
Selecting the predetermined parameters stack from a plurality of parameter stacks, where the selection is executed by logic that determines the selected parameter stack by determining a correspondence between an identifier value in the medical record and a healthcare service personnel specific parameter stack, where the identifier value is an identity of the healthcare service provider.

14. The method of claim 12 further comprising:
Selecting the predetermined parameters stack from a plurality of parameter stacks, where the selection is executed by logic that determines the selected parameter stack by determining a correspondence between an identifier value in the medical record and a healthcare practice specific parameter stack, where the identifier value is an identity of the healthcare practice.

15. The method of claim 12 further comprising:
Selecting the predetermined parameters stack from a plurality of parameter stacks, where the selection is executed by logic that determines the selected parameter stack by determining a correspondence between an identifier value in the medical record and a healthcare field specific parameter stack, where the identifier value is an identity of the healthcare field.

16. The method of claim 12 further comprising:
Selecting the predetermined parameters stack from a plurality of parameter stacks, where the selection is executed by logic that determines the selected parameter stack by determining a correspondence between an identifier value in the medical record and a healthcare field specific parameter stack, where the identifier value is an identity of the healthcare field; and
the identifier value is determined by using a keyword extraction process on the text comprising the medical record.

17. The method of claim 12 further comprising:
determining the healthcare service provider specific parameter set by applying as input to the neural network at least one historical medical record associated with the healthcare service provider; and
using an optimization process applied to adjust the neural network weights, thresholds and interconnectivity, further using at least one preexisting feature set extracted from the at least one historical medical record.

18. The method of claim 12 further comprising:
determining the healthcare field specific parameter set by applying as input to the neural network at least one historical medical record associated with the healthcare field; and
using an optimization process applied to adjust the neural network weights, thresholds and interconnectivity, further using at least one preexisting feature set extracted from the at least one historical medical record.

19. The method of claim 12 further comprising:
determining the healthcare practice specific parameter set by applying as input to the neural network at least one historical medical record associated with a healthcare practice; and
using an optimization process applied to adjust the neural network weights, thresholds and interconnectivity, further using at least one preexisting feature set extracted from the at least one historical medical record.

20. The method of claim 12 further comprising:
Converting at least one identified feature text string to a predetermined synonym text string for that feature by querying a data structure using at least part of the feature text string, said data structure adapted to associate at least one feature text strings with corresponding synonym text strings.

21. The method of claim 12 further comprising:
using the identified feature to select a tally logic for that feature type;
executing the selected tally logic using as input a second identified feature extracted from the medical record object; and
updating a tally value.

22. The system of claim 21 further comprising:
Calculating a quality level for the identified feature using the updated tally value.

23. The method of claim 12 where the detected feature is one of: an alphanumeric string representing the examination completion date and time, a logic value representing whether healthcare service provider notified the referring clinician about the finding, a string representing the delivery date/time of the notification, a value representing the time interval between the examination date and time and the notification date and time and an alphanumeric string representing a healthcare action.

24. The method of claim 23 where the time interval is not detected by the neural network but directly calculated using the logic and the detected features as input to the calculation.
